(19) United States
(12) Patent Application Publication
(10) Pub. No.: US 2026/0133134 A1
(43) Pub. Date: May 14, 2026

(54) OPTICAL HOLE INSPECTION APPARATUS AND METHODS

(71) Applicant: The Boeing Company, Arlington, VA (US)

(72) Inventors: Stephen J. Bennison, Bellevue, WA (US); Mark Douglas Fuller, Snohomish (WA); Austin R. Sivret, Seattle, WA (US); Bruce Stanley Howard, Bellevue, WA (US); Brian T. Miller, Auburn, WA (US)

(21) Appl. No.: 18/946,681

(22) Filed: Nov. 13, 2024

(51) Int. Cl. G01N 21/88; B64F 5/60; G01N 21/954

(52) U.S. Cl. CPC G01N 21/8806; B64F 5/60; G01N 21/8851; G01N 21/954; G01N 2021/8848; G01N 2021/8864; G01N 2021/8877; G01N 2021/9544

(57) ABSTRACT

Optical hole inspection apparatus and methods are disclosed. An example probe for providing an image of an interior of a hole of a structure including a camera coupled to a lens, a tube coupled to the lens adjacent a first end of the tube and coaxial with an axis of the lens, and a mirror coupled to the tube adjacent a second end of the tube opposite the first end to reflect light traveling toward a longitudinal axis of the tube to the lens.

### FIELD OF THE DISCLOSURE

This disclosure relates generally to aircraft inspection and, more particularly, to optical hole inspection apparatus and methods.

### BACKGROUND

One aspect of assembling an aircraft is attaching the skin (e.g., an exterior surface) to the underlying structure (e.g., an airframe) of the aircraft. The skin of the aircraft protects the interior components of the aircraft while simultaneously defining a large portion of the aerodynamics. As such, many portions of the skin include curved shapes with fastener holes or other openings that must be matched with the structures of the aircraft. Manufacturing variation can result in portions of skin that do not mate precisely with the structures. In some cases, this variation results in a gap forming between the skin and the structure at a point where a fastener would be installed. Installing a fastener on such a gap will draw the gap closed and introduce stress into the skin material. This extra stress can damage the skin, weaken the skin, or introduce a deformity (e.g., bumps, buckling, etc.) in the skin. Deformed skin can alter the aerodynamics of the aircraft and introduce unwanted drag.

In order to properly assemble the skin to the structure of the aircraft, fastener holes between the skin and the structure are inspected prior to installing a fastener. A gap between the skin and the structure is commonly measured using a shim or feeler gage. If the gap is measured to be larger than a threshold gap tolerance, the assembly is adjusted, or shims are added to fill the gap. Skin to structure gap inspections are a key process to any aircraft manufacture, influencing its durability when subject to environmental stresses.

### SUMMARY

An example probe for providing an image of an interior of a hole of a structure includes a camera coupled to a lens, a tube coupled to the lens adjacent a first end of the tube and coaxial with an axis of the lens, and a mirror coupled to the tube adjacent a second end of the tube opposite the first end to reflect light traveling toward a longitudinal axis of the tube to the lens.

An example controller for an optical inspection device includes interface circuitry to send data to and receive data from the optical inspection device, machine readable instructions, and programmable circuitry to at least one of instantiate or execute the machine readable instructions to receive image data from the optical inspection device, the image data corresponding to an assembly, analyze the image data to detect a boundary within a hole in the assembly, measure the boundary, and generate measurement data corresponding to the boundary.

An example method of inspecting holes in a structure includes inserting a camera probe into a hole, instructing the camera probe, via a controller, to collect image data corresponding to an interior surface of the hole, and instructing the controller to process the image data to detect a discontinuity on the interior surface of the hole.

### BRIEF DESCRIPTION OF THE DRAWINGS

FIG. 1 is an example optical hole inspection device with an example controller.

FIG. 2A illustrates the example optical hole inspection device of FIG. 1 with an example housing removed to illustrate an example camera and an example lens.

FIGS. 2B-2F illustrate an example optical hole inspection device that includes an example focus adjustment coupled to an example probe tip.

FIG. 3 shows the example optical hole inspection device of FIG. 1 inspecting an example hole in example assembly components.

FIG. 4A is an example image of the example hole of FIG. 3 captured by the optical hole inspection device of FIG. 1.

FIG. 4B is an example analysis of the image of FIG. 4A to determine a boundary of a gap.

FIG. 5 is a block diagram of an example implementation of the optical hole inspection device and the controller of FIG. 1.

FIG. 6 is a flowchart representative of example machine readable instructions and/or example operations that may be executed, instantiated, and/or performed by example programmable circuitry to implement the controller of FIG. 5.

FIG. 7 is a block diagram of an example processing platform including programmable circuitry structured to execute, instantiate, and/or perform the example machine readable instructions and/or perform the example operations of FIG. 6 to implement the controller of FIG. 5.

FIG. 8 is a block diagram of an example implementation of the programmable circuitry of FIG. 7.

FIG. 9 is a block diagram of another example implementation of the programmable circuitry of FIG. 7.

In general, the same reference numbers will be used throughout the drawing(s) and accompanying written description to refer to the same or like parts. The figures are not necessarily to scale.

### DETAILED DESCRIPTION

Known inspection systems for fastener holes and skin to structure gaps in aircraft include feeler gages. Inspecting with feeler gages involves selecting a feeler gage (e.g., a shim) of a known size (e.g., 0.002″, 0.006″, etc.) and attempting to insert the feeler gage into a gap within the fastener hole. An inspector inserts the feeler gage by hand and attempts to move the feeler gage. The inspector determines that the feeler gage is too small (e.g., below the size of the gap) by perceiving a force applied to the feeler gage by the inspector's hand. A low perceived force (e.g., free movement) of the feeler gage indicates that a width of the gap is larger than the feeler gage. Thus, incrementally larger feeler gages are inserted into the gap until the feeler gage thickness approaches the width of the gap. The perceived force of a feeler gage is dependent on an angle of the insertion of the feeler gage (e.g., parallel insertion between the gaps has lower resistance than angled insertion between the gaps), the amount of force used by an inspector, and the inspector's individual perception of force. In this way, feeler gages are inherently subjective as one inspector may determine that a specific feeler gage does not fit within a gap while another inspector may determine that the same feeler gage fits within the gap with minimal perceived force. In other words, the known method of measuring gaps in fastener holes, measuring with feeler gages, is tedious and subjective. This leads to wide variation and poor repeatability across inspectors in an inspection process.

Other known inspection systems for fastener holes between aircraft skin and structures include a video scope with a micrometer attachment. The video scope captures an image of a portion of a fastener hole to detect a gap between the skin and the structure of the aircraft. The video scope is moved manually via the micrometer to measure the gap based on a reference point in the image (e.g., a grid, a line, a center point, etc.). In other words, the reference point is moved to a first side of the gap to establish a zero point and the reference point is moved to a second side of the gap to measure a width of the gap based on the reading of the micrometer. An inspector must determine if the reference point has reached the first side and the second side of the gap, which can be subjective in situations where the gap produces uneven boundaries.

Optical hole inspection apparatus and methods disclosed herein automate gap measurements to remove subjectivity resulting from an inspector's judgement. Optical hole inspection apparatus and methods disclosed herein include a telecentric camera lens to generate undistorted images (e.g., images that do not change based on a distance between an object and a lens of the camera probe) of fastener holes that can be used to find and measure gaps. The images are processed in a controller to detect a presence of a gap and measure a width of the gap. In this way, the gap measurement process is automated to increase repeatability of the measurements. Additionally, optical hole inspection apparatus disclosed herein can be used to inspect and/or measure an interior surface of other holes or openings.

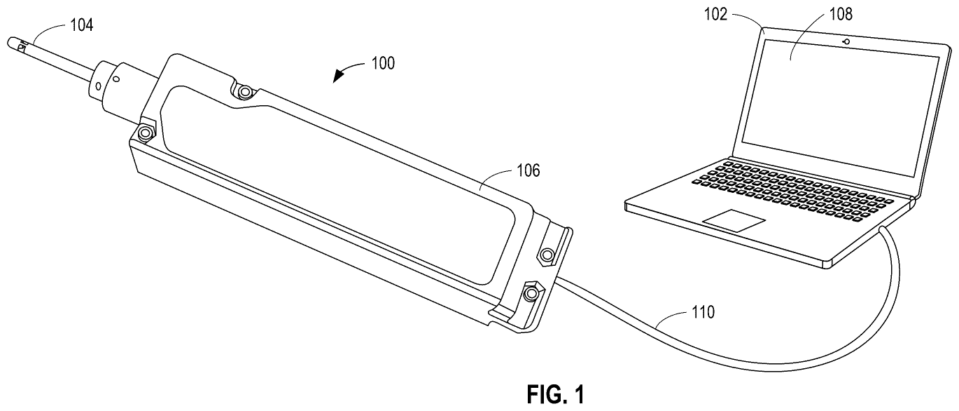

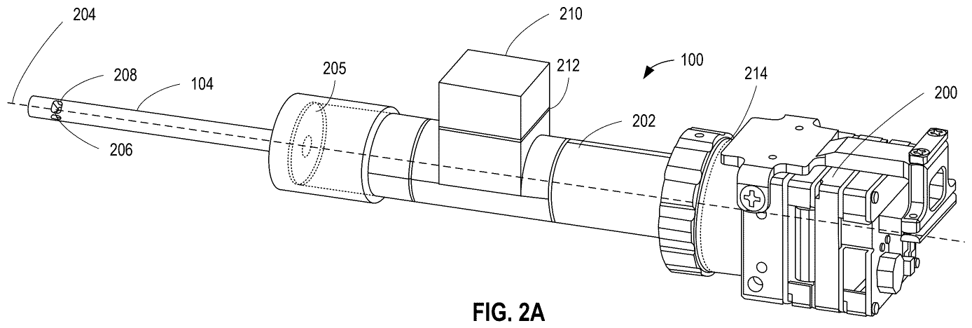

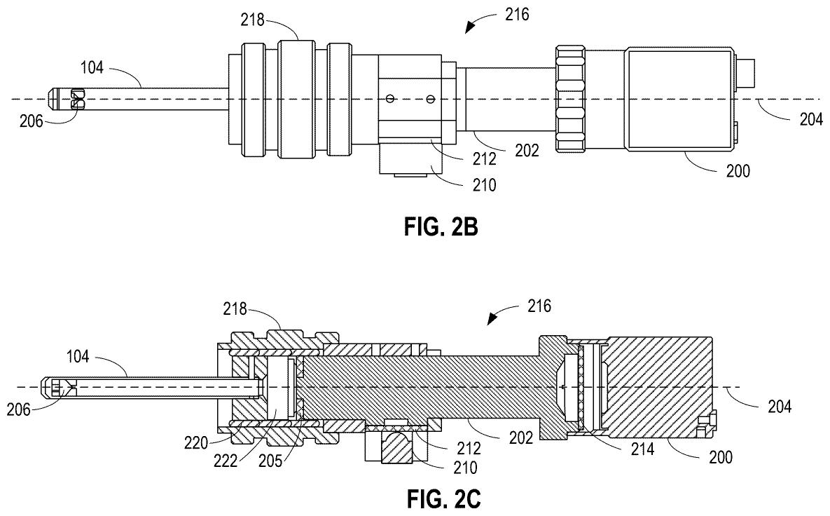

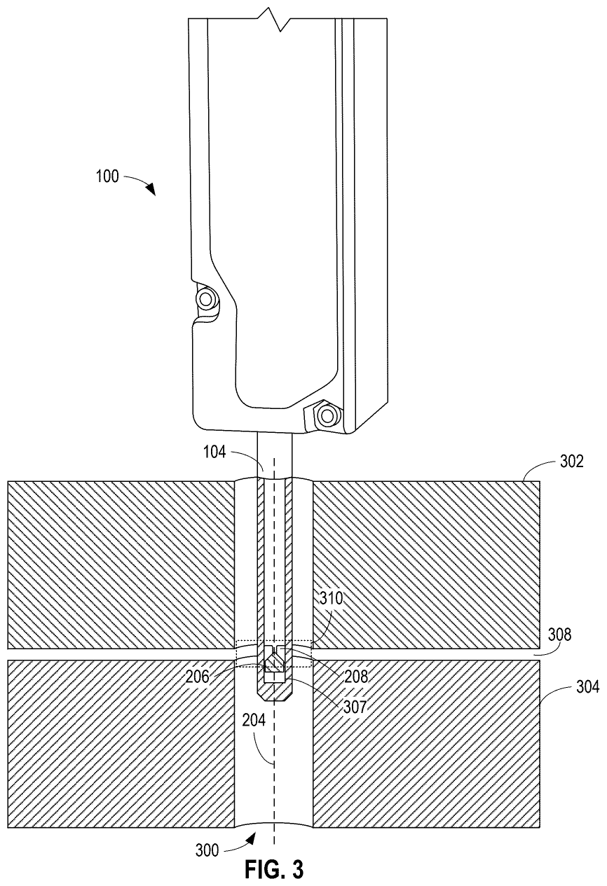

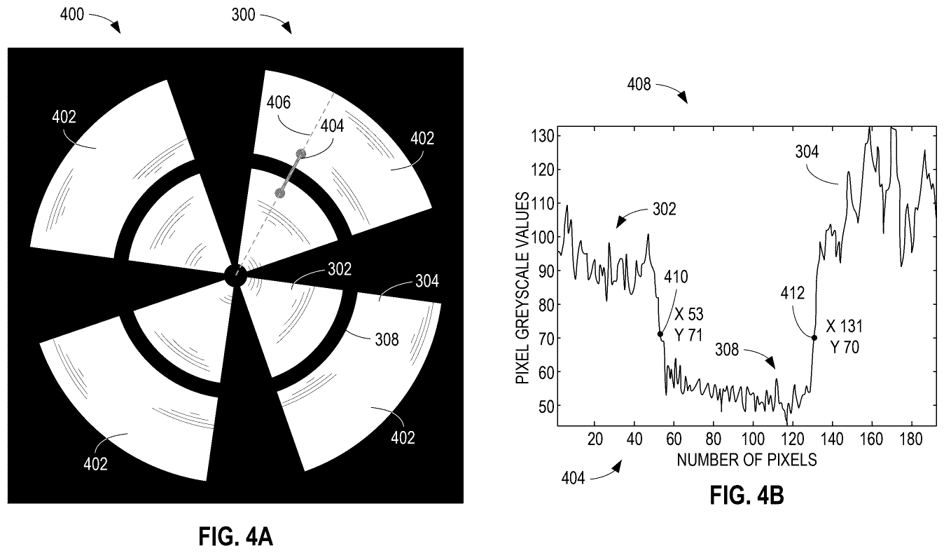

FIG. 1 is an example optical hole inspection device 100 with an example controller 102. The optical hole inspection device 100 (e.g., optical inspection device, camera probe, inspection probe, probe, etc.) is used to inspect a hole (e.g., a fastener hole) and measure an axial feature of the hole (e.g., a gap). The optical hole inspection device 100 includes an example probe tip 104 (e.g., tube, cylindrical tube, etc.) which is inserted into a fastener hole or other joining location (e.g., opening) of an assembly to determine if a gap or other discontinuity (e.g., space, damage, etc.) exists within the hole. As further detailed below in relation to FIGS. 4A and 4B, the optical hole inspection device 100 creates a digital image (e.g., digital image data, image data, etc.) of an interior surface of the hole. In some examples, the digital image corresponds to a boundary between materials of an assembly (e.g., components of the assembly). In some examples, the optical hole inspection device 100 includes an example housing 106 to at least partially surround a digital camera and a lens (further detailed below in relation to FIG. 2A). The housing 106 protects the digital camera and lens and provides a surface to be gripped or otherwise held by a user.

The example controller 102 of FIG. 1 sends control commands to the optical hole inspection device 100 and receives image data (e.g., digital image files, video files, visual data, etc.) from the optical hole inspection device 100. The controller 102 receives user inputs to direct the controller 102 to analyze the image data to detect and/or measure gaps or other features within the image data, as further detailed below in relation to FIGS. 4A-4B. In some examples, the controller 102 includes an example screen 108 (e.g., touch screen) to display image data and/or gap measurements. An example signal cable 110 connects the controller 102 to the optical hole inspection device 100. The signal cable 110 communicatively couples the controller 102 and the optical hole inspection device 100. In this way, the controller 102 can send control commands to the optical hole inspection device 100 and the optical hole inspection device 100 can send data to the controller 102. In some examples, the signal cable 110 sends power to the optical hole inspection device 100.

FIG. 2A illustrates the example optical hole inspection device 100 of FIG. 1 with the example housing 106 removed to illustrate an example camera 200 and an example lens 202. The optical hole inspection device 100 includes the example camera 200, the example lens 202, and the example probe tip 104. The camera 200 is coupled to the lens 202 such that the camera 200 and the lens 202 share an example optical axis 204 (e.g., longitudinal axis). The lens 202 is optically centered around the axis 204. The lens 202 is shown with an example cylindrical shape and an example length. In other examples, the lens 202 can have a different shape and/or a different length. The lens 202 contains optical elements (e.g., lenses, compound lenses, etc.) that manipulate light before the light enters the camera 200. In some examples, the lens 202 is a telecentric lens positioned relative to the camera 200 to maintain a size (e.g., scale) of an image regardless of distance between a source of the image and the camera 200. In this way, the image data generated by the camera 200 can be used to precisely measure features of an interior surface of the fastener hole.

The probe tip 104 of FIG. 2A is coupled to the lens 202 opposite the camera 200, adjacent a first end of the probe tip 104. The probe tip 104 is hollow and centered on the axis 204 so that the probe tip 104 is coaxial with the lens 202. In some examples, the probe tip 104 is smaller than the lens 202 and the lens 202 includes an example light absorbing material 205 (e.g., flock paper) to reduce light reflections from within the lens 202. The probe tip 104 is shown with an example length and an example diameter. In other examples, the probe tip 104 can have a different diameter and/or a different length. The probe tip 104 is shown with a cylindrical shape. In other examples, the probe tip 104 can have a different shape or cross-section (e.g., a square tube, a hexagonal tube, etc.). The probe tip 104 includes an example mirror 206 coupled to the probe tip 104 adjacent a second end of the probe tip 104, opposite the lens 202. In some examples, the probe tip 104 extends past the mirror 206 and away from the lens 202. In other examples, the probe tip 104 ends at the mirror 206.

The mirror 206 of FIG. 2A is inserted into an assembly so that the optical hole inspection device 100 can create image data of an interior surface of a fastener hole (e.g., a sidewall of a hole). The mirror 206 reflects light parallel to the axis 204 (e.g., light traveling away from the lens 202) in a direction perpendicular to the axis 204 (e.g., transverse a longitudinal axis of the probe tip 104) and reflects light from perpendicular to the axis 204 (e.g., light traveling toward the longitudinal axis of the probe tip 104) in a direction parallel to the axis 204 (e.g., towards the lens 202). In other words, the mirror 206 is positioned relative to the axis 204 such that it reflects light (e.g., an image) of an interior surface of a fastener hole (e.g., a hole, an opening, etc.) so that the camera 200 can generate image data corresponding to the interior surface of the fastener hole. In some examples, the mirror 206 is a conical mirror (e.g., a right circular cone, a 45 degree cone, etc.) that shares an axis with the axis 204 and has a vertex on the axis 204. In this way, the mirror 206 reflects light from a cylindrical area around the mirror 206, through the lens 202, and to the camera 200. The probe tip 104 includes example openings 208 to allow light to travel to the mirror 206. In this way, the probe tip 104 supports the mirror 206 while allowing light to pass through the probe tip 104 via the openings 208. The probe tip 104 of FIG. 2A includes four openings 208. In other examples, the probe tip 104 can have a different number of openings 208 (e.g., two openings 208, three openings 208, etc.).

The example lens 202 of FIG. 2A includes an example light source 210 (e.g., a light emitting diode) coupled to the lens 202 to direct light towards the mirror 206. In this way, light is reflected perpendicular to the axis 204 to illuminate the inner surface of the hole. In some examples, the lens 202 includes an example first polarizer 212 and an example second polarizer 214. The light from the light source 210 is polarized by the first polarizer 212 before the light is reflected (e.g., by a beam splitter) towards the mirror 206. Any light from the light source 210 that reflects within the lens 202 toward the camera 200 is filtered by the second polarizer 214 that is oriented 90 degrees from the first polarizer 212. Thus, the camera 200 receives light reflected from the inner surface of the hole and not light reflected from within the lens 202. The first polarizer 212, the second polarizer 214, and the light absorbing material 205 reduce light reflection within the lens 202 so that the camera 200 produces higher contrast images from the inner surface of the hole. In some examples, the light source 210 produces a different color of light (e.g., blue light, red light, etc.) based on a user input. In this way, light produced by the light source 210 can be adjusted in response to the materials of the inner surface of the hole to increase the contrast of the images produced by the camera 200. In some examples, the optical hole inspection device 100 is adjusted to change an intensity of the light produced by the light source 210 and/or an exposure of the camera 200 based on a reflectivity of the inner surface of the hole. In this way, the contrast of the images produced by the camera 200 can be improved. In some examples, two images are generated by the camera 200 with different light intensities and/or exposures to be later combined for analysis. In this way, high contrast images of holes shared by materials of differing reflectivity (e.g., high reflectivity titanium and low reflectivity graphite) can be generated.

FIGS. 2B-2E illustrate an example optical hole inspection device 216 that includes an example focus adjustment 218 coupled to the probe tip 104. For clarity, the optical hole inspection device 216 is shown without a housing. The optical hole inspection device 216 of FIGS. 2B-2E is similar to the optical hole inspection device 100 in form and operation, with the addition of the focus adjustment 218. As such, many components of the optical hole inspection device 216 are similar to or identical to the components of the optical hole inspection device 100.

The focus adjustment 218 of FIGS. 2B-2E is coupled to the lens 202 opposite the camera 200. The probe tip 104 is coupled to the focus adjustment 218 and extends away from the lens 202. The lens 202, the focus adjustment 218, and the probe tip 104 share the common axis 204. The focus adjustment 218 translates the probe tip 104 along the axis 204 based on rotation of the focus adjustment 218 relative to the lens 202. Thus, the focus adjustment 218 alters a distance between the mirror 206 and the camera 200 based on a rotational position of the focus adjustment 218. In this way, an optical focus of the optical hole inspection device 216 is changed. Changing the optical focus of the optical hole inspection device 216 allows the optical hole inspection device 216 to take images within holes of varying diameter. In this way, the optical hole inspection device 216 can be inserted into a hole to be inspected and the focus adjustment 218 can be actuated (e.g., rotated) to change the optical focus of the optical hole inspection device 216 to coincide with a circumference of the hole.

FIG. 2C shows the optical hole inspection device 216 of FIG. 2B in cross section to illustrate the focus adjustment 218. In some examples, the focus adjustment 218 includes an example helicoid 220 (e.g., a helical groove) to translate the probe tip 104. An example base 222 is coupled to the probe tip 104. The base 222 is rotationally fixed and extends into the helicoid 220. Thus, the base 222 translates along the axis 204 and moves the probe tip 104 in response to rotation of the helicoid 220. FIG. 2D shows an example sleeve 224 that removably couples to the optical hole inspection device 216. The sleeve 224 has an inner diameter that matches an outer diameter of the probe tip 104. The sleeve 224 has an outer diameter that is larger than the outer diameter of the probe tip 104. In this way, the sleeve 224 is coupled to the optical hole inspection device 216 to increase a functional diameter of the probe tip 104. The sleeve 224 increases the functional diameter of the probe tip 104 so that the sleeve 224 can contact an inner surface of a hole to be measured. In this way, the probe tip 104 is positioned closer to a central axis of the hole. In other words, the sleeve 224 can increase the functional diameter of the probe tip 104 to more closely match the diameter of the hole and, thus, more closely align the axis 204 with the central axis of the hole. When the axis 204 is aligned with the central axis of the hole to be inspected, the image generated by the camera 200 will more accurately represent the interior surface of the hole as all portions of the interior surface of the hole will be in focus. In other words, if the probe tip 104 has a substantially smaller diameter than the hole to be measured, the probe tip 104 can be positioned closer to one side of the hole which can negatively impact the focus and quality of an image generated by the camera 200. In some examples, multiple sleeves 224 of varying diameters can be prepared for use with the optical hole inspection device 216, and a sleeve 224 of appropriate diameter can be coupled to the optical hole inspection device 216 to match a hole to be inspected. In some examples, the base 222 includes a ferromagnetic material and the sleeve 224 is coupled to the base 222 by magnets.

FIG. 2E illustrates the optical hole inspection device 216 with an example centering cone 226 to center the probe tip 104 within a hole. The centering cone 226 is angled such that a top surface of the centering cone 226 (e.g., a surface opposite the lens 202) grows in diameter as the top surface nears the focus adjustment 218. The centering cone 226 surrounds the probe tip 104 such that the center cone 226 and the probe tip 104 are concentric. In some examples, the centering cone 226 translates along the probe tip 104 and the centering cone 226 includes an example spring 228 to bias the centering cone away from the focus adjustment 218. Similarly to the sleeve 224 of FIG. 2D, the centering cone 226 contacts the edges of a hole to be measured to ensure that the probe tip 104 is centered within the hole. The conical surface of the centering cone 226 advantageously allows the centering cone 226 to contact holes of different diameters without needing to be sized to match a particular hole diameter.

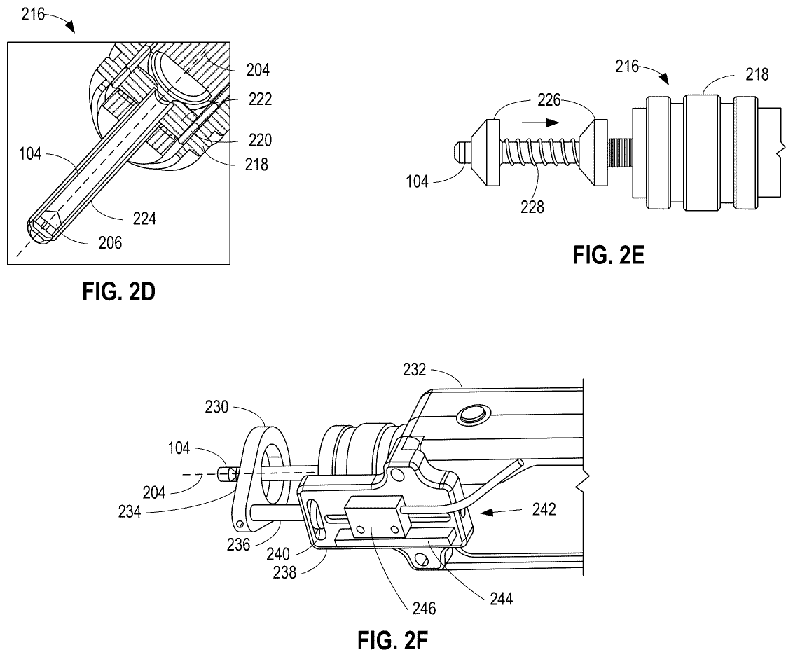

FIG. 2F illustrates the optical hole inspection device 216 with an example foot 230 coupled to an example housing 232. The foot 230 controls how deep the probe tip 104 enters a hole for inspection. The foot 230 includes an example planar surface 234 that is orthogonal to the axis 204 and contacts a top surface of an assembly to be measured. In this way, the position of the foot 230 relative to the housing 232 determines a depth that the probe tip 104 enters into the hole. The position of the foot 230 relative to the housing 232 is changed by translating an example lead screw 236. The lead screw 236 is rotationally fixed and coupled to an example bracket 238 via an example thumb wheel 240. The lead screw 236 translates relative to the housing 232 based on rotation of the thumb wheel 240. In this way, the depth of the probe tip 104 can be adjusted to align with a boundary within the hole (as further detailed in relation to FIG. 3).

In some examples, an example linear encoder 242 is coupled to the bracket 238 of FIG. 2F to provide position data corresponding to the depth of the probe tip 104 in the hole. An example scale 244 of the linear encoder 242 is coupled to the bracket 238 and an example sensor 246 of the linear encoder 242 is coupled to the lead screw 236. As the lead screw 236 translates parallel to the axis 204, the sensor 246 moves along the scale 244 a corresponding amount. The sensor 246 generates position data that corresponds to the motion of the foot 230. The difference between a known position of the probe tip 104 and the sensed position of the planar surface 234 of the foot 230 determines the depth of the probe tip 104 within the hole to be measured. In some examples, the foot 230 is actuated by different means (e.g., rack and pinion, locking slider, etc.) coupled to the linear encoder 242. In other examples, the foot 230 is coupled to the bracket 238 via a slide to allow the foot 230 to move parallel to the axis 204 without needing to be unlocked or adjusted by a user. The foot 230 is biased (e.g., pushed by a compression spring) to extend away from the housing 232. In this way, the foot 230 is free to move in response to contact to the top surface of the assembly. The sensor 246 is coupled to the slide, and the linear encoder 242 measures the position of the foot 230 to allow tracking of the depth of the probe tip 104. In some examples, the position of the foot 230 (e.g., the depth of the probe tip 104 within the hole) is used to trigger the camera 200 to capture an image and/or to adjust the light generated by the light source 210.

FIG. 3 shows the example optical hole inspection device 100 of FIG. 1 inspecting an example hole 300 in example assembly components 302,304. The hole 300, the assembly components 302,304, and the probe tip 104 are shown in cross-section to illustrate an inspection of an example interior surface 306 of the hole 300. In some examples, the hole 300 is a fastener hole and the assembly components 302,304 are aircraft components (e.g., a skin of an aircraft, a structure of the aircraft, etc.). The mirror 206 is coupled to an inner surface 307 of the probe tip 104.

An example boundary 308 (e.g., a gap, a seam, a discontinuity, etc.) is located between the assembly components 302,304 of FIG. 3. The mirror 206 and the openings 208 of the probe tip 104 produce an example field of view 310. The field of view 310 of the mirror 206 includes a circumference of the hole 300 from which the mirror 206 can reflect light from the boundary 308 to determine if a gap (e.g., a space, a non-contact area) exists between the assembly components 302,304. In other examples, the optical hole inspection device 100 can be used to locate and/or measure other features and/or defects in a hole.

FIG. 4A is an example image 400 of the example hole 300 captured by the optical hole inspection device 100 of FIG. 3. The image 400 (e.g., image data) is created by the camera 200 (not shown) receiving light from the example interior surface 306 of the example hole 300 (e.g., the field of view 310) as it is reflected off of the mirror 206. The image 400 includes sectors 402 that correspond to the example openings 208 of the probe tip 104 (not shown). The sectors 402 show the example boundary 308 as a ring (e.g., an annular shape) between the example assembly components 302,304. The areas between the sectors 402 do not show light as they correspond to portions of the probe tip 104 that surround the openings 208 and support the mirror 206 (not shown). The image 400 of FIG. 4A includes four sectors 402 that correspond to four openings 208 in the probe tip 104 (not shown). In other examples, the image 400 may have a different number of sectors 402 (e.g., two sectors 402, three sectors 402, etc.) that correlate to a different number of openings 208 (e.g., two openings 208, three openings 208, etc.). The boundary 308 and the assembly components 302,304 are depicted in the image 400 as annular shapes (e.g., rings, concentric circles, etc.) as a result of the example cylindrical field of view 310 being reflected to a planar surface of the camera 200 by the example conical mirror 206. In other words, the two-dimensional image 400 is a projection of the three-dimensional inner surface 306 of the hole 300. The dark boundary 308 has a thickness that corresponds to a width of a gap between the assembly components 302,304.

An example analysis line segment 404 is placed across the boundary 308 of FIG. 4A to select a portion of the image 400 for later analysis. The analysis line segment 404 is coincident with an example radial line 406 that extends from a center point of the image 400. In some examples, the analysis line segment 404 is generated by a user input. In some examples, the analysis line segment 404 is generated based on a user input that has been adjusted to be coincident with a radial line (e.g., the radial line 406). Detecting an edge (e.g., a boundary, a feature, etc.) along a radial line in the image 400 allows for axial measurement (e.g., axial locating) of the edge within the hole 300, as radial lines represent lines parallel to the axis 204 of the optical hole inspection device 100 (not shown). In some examples, a user selects multiple points (e.g., 3 points, 5 points, 10 points, etc.) along the boundary 308 to define a first ellipse (e.g., a first circle) that corresponds to an edge of the component 302 and a second ellipse (e.g., second circle) that corresponds to an edge of the component 304, and multiple (e.g., 4, 25, 100, etc.) analysis line segments 404 are generated between the first ellipse and the second ellipse. In some examples, the first ellipse and the second ellipse are best fit to the user selected points.

FIG. 4B is an example analysis 408 of the image 400 of FIG. 4A to determine a boundary of a gap. In some examples, the image 400 is a greyscale image where each pixel of the image 400 includes a light intensity value (e.g., grayscale value) from black to white. The analysis line segment 404 on the image 400 is analyzed for a change in light intensity beyond a threshold value. The analysis 408 shows light intensity values for each pixel of the analysis line segment 404. An example gap start point 410 is assigned after a drop in intensity beyond the threshold value is detected. In this way, the gap start point 410 is a detected edge of the example assembly component 302. From the start point 410, the boundary 308 is represented by the low light intensity (e.g., dark) values. An example gap end point 412 is assigned after an increase in the light intensity beyond the threshold value is detected. In this way, the gap end point 412 is a detected edge of the example assembly component 304. A number of pixels between the gap start point 410 and the gap end point 412 can be directly correlated to a measured width of the gap (e.g., an axial separation between assembly components 302,304) at the boundary 308. In some examples, the image 400 is a telecentric image where every pixel represents a known distance (e.g., 0.0001″, 0.00003″, etc.).

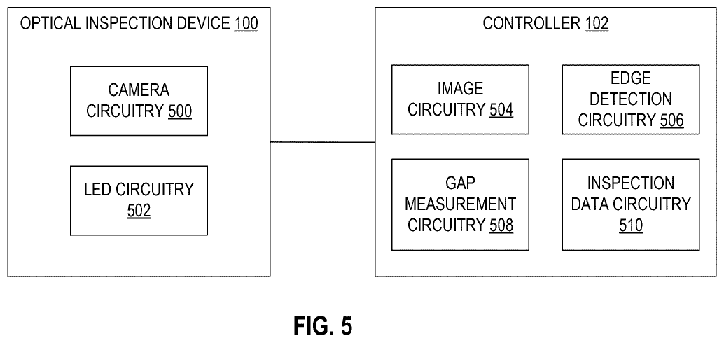

FIG. 5 is a block diagram of an example implementation of the optical hole inspection device 100 and the controller 102 of FIG. 1. The controller 102 (e.g., human machine interface, computing device, etc.) of FIG. 5 may be instantiated (e.g., creating an instance of, bring into being for any length of time, materialize, implement, etc.) by programmable circuitry such as a Central Processor Unit (CPU) executing first instructions. Additionally or alternatively, the controller 102 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The optical hole inspection device 100 of FIG. 5 includes example camera circuitry 500 and example light emitting diode (LED) circuitry 502. The example camera circuitry 500 receives image data from a camera (e.g., the camera 200) and sends it to the controller 102 for later use. The LED circuitry 502 controls a light source (e.g., the light source 210) to provide light to fastener holes that are being inspected. In some examples, the LED circuitry 502 alters a quality (e.g., a brightness, a color, etc.) of the light generated by the light source.

The controller 102 of FIG. 5 includes example image circuitry 504, example edge detection circuitry 506, example gap measurement circuitry 508, and example inspection data circuitry 510.

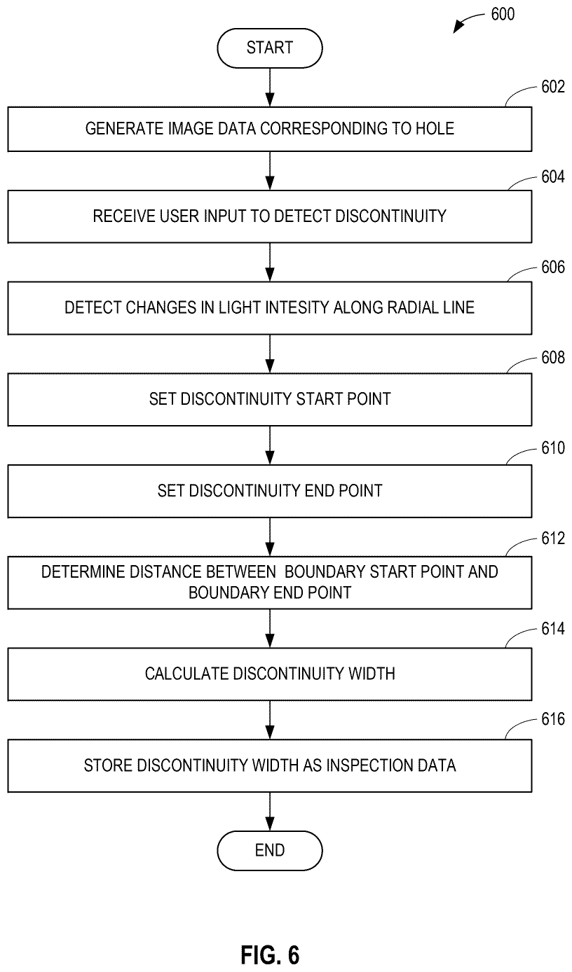

The image circuitry 504 of the controller 102 of FIG. 5 receives and processes image data received from the camera circuitry 500. In some examples, the image circuitry 504 prepares image data (e.g., crops, color adjusts, etc.) to be viewed and/or analyzed by the controller 102. The image circuitry 504 stores image data in response to receiving a user input. This stored image data is used for later processing with the edge detection circuitry 506 and the gap measurement circuitry 508. In some examples, the image circuitry 504 is instantiated by programmable circuitry executing image instructions and/or configured to perform operations such as those represented by the flowchart of FIG. 6.

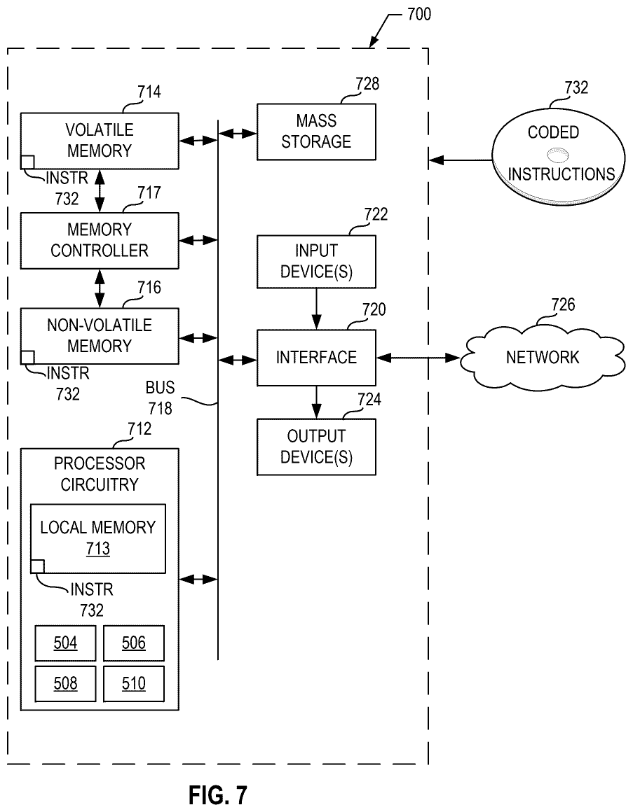

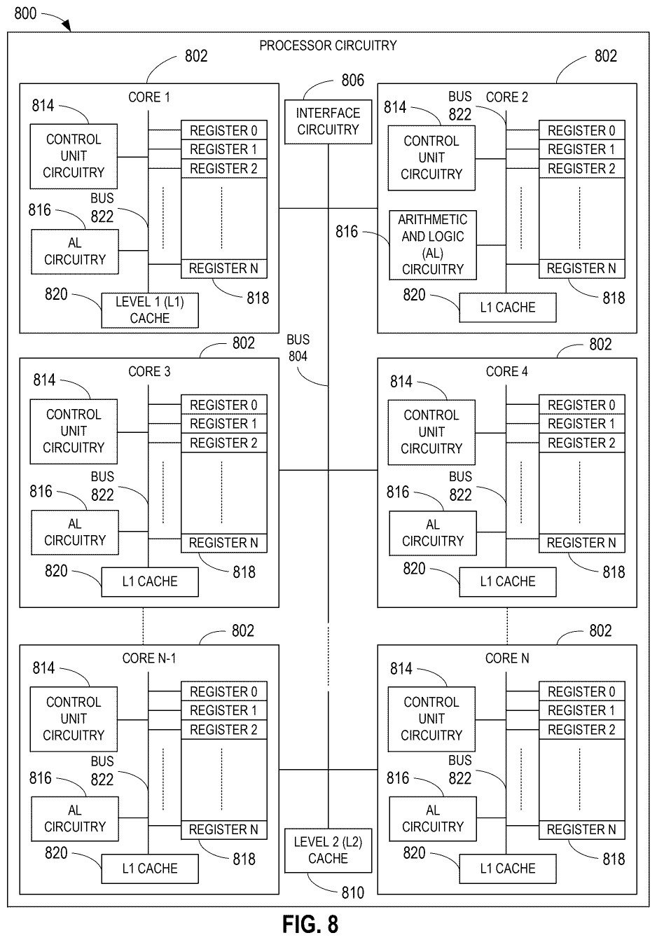

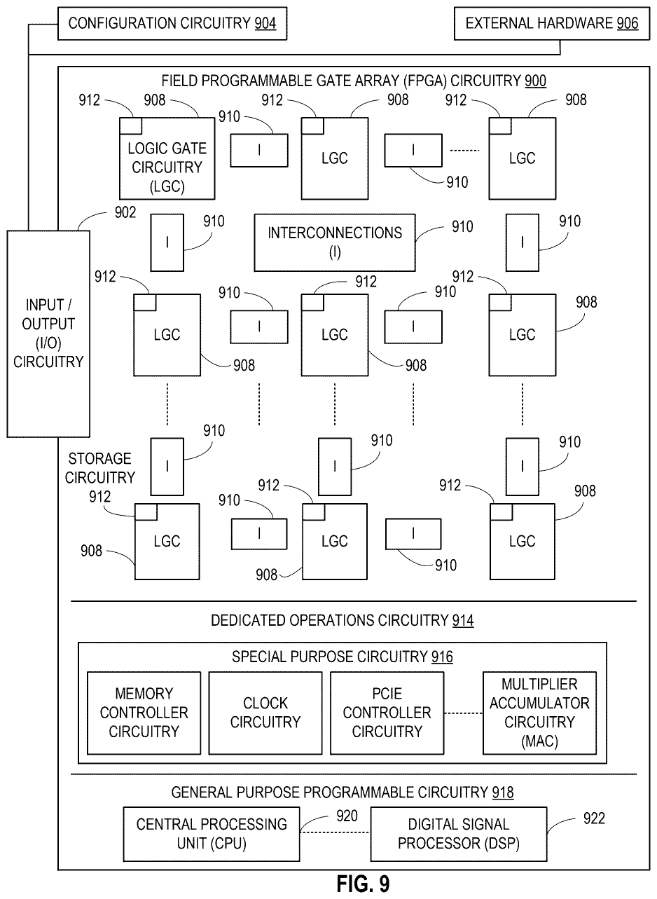

In some examples, the controller 102 includes means for receiving images. For example, the means for receiving may be implemented by image circuitry 504. In some examples, the image circuitry 504 may be instantiated by programmable circuitry such as the example programmable circuitry 712 of FIG. 7. For instance, the image circuitry 504 may be instantiated by the example microprocessor 800 of FIG. 8 executing machine executable instructions such as those implemented by at least block 602 of FIG. 6. In some examples, the image circuitry 504 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the image circuitry 504 may be instantiated by any other combination of hardware, software, and/or firmware. For example, the image circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The edge detection circuitry 506 of the controller 102 of FIG. 5 analyzes image data for an edge or boundary. The edge detection circuitry 506 analyzes image data corresponding to a fastener hole (e.g., the hole 300) in an assembly. The fastener hole includes two assembly components (e.g., the assembly components 302,304) to be fastened together. The edge detection circuitry 506 determines a location of a boundary (e.g., the boundary 308) between the two assembly components. Image data received from the camera circuitry 500 and the image circuitry 504 shows such a boundary as a circle or ring within the image data with low light intensity.

The edge detection circuitry 506 of the controller 102 of FIG. 5 receives a user input to designate a portion of the image data (e.g., a line, a line segment, etc.) to analyze for a boundary. In some examples the user input is an analysis line segment (e.g., the analysis line segment 404). In other examples, the user input is a line segment used to generate a radial analysis line segment that is coincident with a line (e.g., the radial line 406) extending from a center point of the image data. The analysis line segment denotes a series of pixels from the image data to be analyzed. The analysis line segment is analyzed to identify changes in light intensity beyond a threshold value, as discussed above in reference to FIG. 4B. In this way, a gap start point and a gap end point (e.g., the gap start point 410, the gap end point 412) are detected corresponding to the analysis line segment. The gap start point represents a pixel of image data on an edge of the boundary closest to the center point. The gap end point represents a pixel of image data on an edge of the boundary furthest from the center point. Thus, the edge detection circuitry 506 uses the gap start point to define a first edge of the boundary between the assembly components and the gap end point to define a second edge of the boundary between the assembly components. In some examples, the edge detection circuitry 506 receives user inputs (e.g., user selected points, user selected pixels, etc.) corresponding to the first edge of the boundary and the second edge of the boundary. The edge detection circuitry 506 fits ellipses to the user inputs to define the first edge and the second edge, and a plurality of gap start points and gap end points are selected along the ellipses. In some examples, the edge detection circuitry 506 is instantiated by programmable circuitry executing edge detection instructions and/or configured to perform operations such as those represented by the flowchart of FIG. 6.

In some examples, the controller 102 includes means for detecting an edge. For example, the means for detecting may be implemented by edge detection circuitry 506. In some examples, the edge detection circuitry 506 may be instantiated by programmable circuitry such as the example programmable circuitry 712 of FIG. 7. For instance, the edge detection circuitry 506 may be instantiated by the example microprocessor 800 of FIG. 8 executing machine executable instructions such as those implemented by at least blocks 606, 608, and 610 of FIG. 6. In some examples, edge detection circuitry 506 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the edge detection circuitry 506 may be instantiated by any other combination of hardware, software, and/or firmware. For example, the edge detection circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The gap measurement circuitry 508 determines a width of a gap between two assembly components. The gap measurement circuitry 508 receives the gap start point and the gap end point (e.g., data correlating to the first edge of the boundary and the second edge of the boundary, the gap start point 410 and the gap endpoint 412) from the edge detection circuitry 506. The gap measurement circuitry 508 calculates a length (e.g., a width, an axial distance) between the gap start point and the gap end point. In some examples, the difference in length is a pixel count that is later multiplied by a scaling factor to determine a length in other units (e.g., inches, millimeters, etc.). Once the length between the gap start point and the gap end point is determined, the gap measurement circuitry 508 stores the length as gap width data. In some examples, if the length between the gap start point and the gap end point is within a threshold distance of zero (e.g., less than 0.001 inch), the gap measurement circuitry 508 determines that there is no gap between the first assembly component and the second assembly component. In some examples, there are multiple gap start points and gap end points and the gap width data includes an average length, a median length, a maximum length, a minimum length, and/or any other statistical evaluation of lengths. In some examples, the gap measurement circuitry 508 is instantiated by programmable circuitry executing gap measurement instructions and/or configured to perform operations such as those represented by the flowchart of FIG. 6.

In some examples, the controller 102 includes means for measuring a gap. For example, the means for measuring may be implemented by gap measurement circuitry 508. In some examples, the gap measurement circuitry 508 may be instantiated by programmable circuitry such as the example programmable circuitry 712 of FIG. 7. For instance, the gap measurement circuitry 508 may be instantiated by the example microprocessor 800 of FIG. 8 executing machine executable instructions such as those implemented by at least blocks 612 and 614 of FIG. 6. In some examples, the gap measurement circuitry 508 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the gap measurement circuitry 508 may be instantiated by any other combination of hardware, software, and/or firmware. For example, the gap measurement circuitry 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The inspection data circuitry 510 of the controller 102 of FIG. 5 generates inspection data correlating to a fastener hole that has been inspected for a gap. The inspection data circuitry 510 determines a time that image data was received by the image circuitry 504. The inspection data circuitry 510 receives gap width data from the gap measurement circuitry 508. The inspection data circuitry 510 stores the time data and the gap width data as inspection data (e.g., measurement data) in the controller 102. In some examples, the inspection data circuitry 510 stores image data from the image circuitry 504 as inspection data. In some examples, the inspection data circuitry 510 stores position data (e.g., data from the linear encoder 242) corresponding to a depth within the hole at which the image data was created. In some examples, the inspection data circuitry 510 is instantiated by programmable circuitry executing inspection data generating instructions and/or configured to perform operations such as those represented by the flowchart of FIG. 6.

In some examples, the controller 102 includes means for generating inspection data. For example, the means for generating may be implemented by inspection data circuitry 510. In some examples, the inspection data circuitry 510 may be instantiated by programmable circuitry such as the example programmable circuitry 712 of FIG. 7. For instance, the inspection data circuitry 510 may be instantiated by the example microprocessor 800 of FIG. 8 executing machine executable instructions such as those implemented by at least block 616 of FIG. 6. In some examples, inspection data circuitry 510 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the inspection data circuitry 510 may be instantiated by any other combination of hardware, software, and/or firmware. For example, the inspection data circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the controller 102 of FIG. 1 is illustrated in FIG. 5, one or more of the elements, processes, and/or devices illustrated in FIG. 5 may be combined, divided, re-arranged, omitted, eliminated, and/or implemented in any other way. Further, the example image circuitry 504, the example edge detection circuitry 506, the example gap measurement circuitry 508, the example inspection data circuitry 510, and/or, more generally, the example controller 102 of FIG. 5, may be implemented by hardware alone or by hardware in combination with software and/or firmware. Thus, for example, any of the example image circuitry 504, the example edge detection circuitry 506, the example gap measurement circuitry 508, the example inspection data circuitry 510, and/or, more generally, the example controller 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controller 102 of FIG. 5 may include one or more elements, processes, and/or devices in addition to, or instead of, those illustrated in FIG. 5, and/or may include more than one of any or all of the illustrated elements, processes and devices.

A flowchart representative of example machine readable instructions, which may be executed by programmable circuitry to implement and/or instantiate the controller 102 of FIG. 5 and/or representative of example operations which may be performed by programmable circuitry to implement and/or instantiate the controller 102 of FIG. 5, are shown in FIG. 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 6, many other methods of implementing the example controller 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to inspect a hole. The example machine-readable instructions and/or the example operations 600 of FIG. 6 begin at block 602, at which image data corresponding to a hole (e.g., a fastener hole, the hole 300, etc.) is generated by a camera (e.g., the camera 200) of a camera probe (e.g., the optical hole inspection device 100). The image data is transferred to the image circuitry 504 via the camera circuitry 500. The optical hole inspection device 100 is inserted into the hole with the probe tip 104 positioning the mirror 206 near a boundary. The image data corresponds to the observation window (e.g., the field of view 310) of the camera probe as reflected by a mirror (e.g., the mirror 206, a conical mirror, etc.).

The operations 600 of FIG. 6 continue to block 604, at which the controller 102 receives a user input to detect a discontinuity (e.g., a gap, a boundary, etc.) within the image data. In other words, the controller 102 receives a user input to use image data currently received by the example image circuitry 504 for a gap measurement. In some examples, the user input includes an analysis line segment (e.g., the analysis line segment 404). In some examples, the user input includes a plurality of points (e.g., 3 points, 5 points, etc.) on a first side of the boundary and a plurality of points on a second side of the boundary to define ellipses (e.g., circles) that match the boundary. The operations 600 continue to block 606, at which the edge detection circuitry 506 detects a change in light intensity along a radial line (e.g., the radial line 406). The edge detection circuitry 506 detects changes in light intensity (e.g., grayscale value) in the image data along the radial line. In some examples, the edge detection circuitry 506 detects changes in light intensity along a portion of a radial line indicated by the analysis line segment. Light intensity is tracked sequentially (e.g., pixel to pixel) to find changes in light intensity (e.g., brightness, grayscale value, etc.) that exceed a threshold value. In some examples, the light intensity is determined by a moving average to compensate for variation in the image data.

Once light intensity changes have been analyzed, the operations 600 continue to block 608, at which the edge detection circuitry 506 sets (e.g., defines) a discontinuity start point (e.g., the gap start point 410). The gap start point is a point (e.g., a pixel location, a coordinate, etc.) within the image data. The edge detection circuitry 506 identifies a point along the radial line closest to the center of the image data where the light intensity changes (e.g., decreases) beyond the threshold value and assigns that point as a discontinuity start point. In some examples, the image data does not include light intensity changes beyond the threshold value and no discontinuity start point is assigned. In some examples, the discontinuity start point is assigned by an intersection between a radial line and the first user defined ellipse.

The operations 600 continue to block 610, where the edge detection circuitry 506 defines a discontinuity end point (e.g., the gap end point 412). The discontinuity end point is a point (e.g., a location, a coordinate, etc.) within the image data. The edge detection circuitry 506 identifies a point along the radial line that is positioned after (e.g., further from the center than) the discontinuity start point of the image data, where the light intensity changes (e.g., increases) beyond the threshold value, and assigns that point as a discontinuity end point. In some examples, the radial line does not include light intensity changes beyond the threshold values and no discontinuity end point is assigned. In some examples, the discontinuity end point is assigned by an intersection with a radial line and the second user defined ellipse.

The operations 600 of FIG. 6 continues to block 612, at which the gap measurement circuitry 508 determines a distance between the discontinuity start point and the discontinuity end point. In some examples, the distance between the discontinuity start point and the discontinuity end point is a number of pixels between the discontinuity start point and the discontinuity end point. In other examples, the distance between the discontinuity start point and the discontinuity end point is a calculated pixel distance based on coordinates of the discontinuity start point and coordinates of the discontinuity end point. In some examples, a plurality of discontinuity start points and discontinuity end points are defined, and a plurality of distances are determined. If a discontinuity start point and a discontinuity end point have not been assigned, the distance is determined to be zero.

The operations 600 of FIG. 6 move to block 614, at which the gap measurement circuitry 508 calculates a width (e.g., a gap width) of the discontinuity (e.g., axial feature, boundary, etc.). In other words, the gap measurement circuitry 508 calculates an axial distance within the hole between the discontinuity start point and the discontinuity end point based on the image data. The distance determined at block 612 is multiplied by a scaling value to convert the distance in the image data into a real world measurement (e.g., inches, millimeters, etc.). In some examples, the scaling value is predetermined by measuring a hole discontinuity of a known width (e.g., by measuring a calibration assembly). In some examples, a plurality of widths are calculated based on a plurality of distances. If the width is found to be below a threshold value, the gap measurement circuitry 508 determines that the width is zero and no discontinuity has been detected.

The operations 600 conclude at block 616, where the width of the discontinuity is stored as inspection data (e.g., measurement data) by the controller 102. The inspection data circuitry 510 receives time data from the controller 102 and discontinuity width data from the gap measurement circuitry 508. The discontinuity width data includes a width of the discontinuity or a determination that no discontinuity was detected. In some examples, the discontinuity width data includes a plurality of discontinuity widths, an average width, a median width, a maximum width, a minimum width, and/or any other statistical measure of calculated widths. The time data and the discontinuity width data are stored as inspection data by the inspection data circuitry 510. The inspection data is a record of an inspection of a hole (e.g., an inspection event). In some examples, the inspection data includes the visual data that was analyzed by the controller 102. Once the inspection data has been stored, the operations 600 end.

FIG. 7 is a block diagram of an example programmable circuitry platform 700 structured to execute and/or instantiate the example machine-readable instructions and/or the example operations of FIG. 6 to implement the controller 102 of FIG. 5. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example image circuitry 504, the example edge detection circuitry 506, the example gap measurement circuitry 508, and the example inspection data circuitry 510.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIG. 6 to effectively instantiate the circuitry of FIG. 5 as logic circuits to perform operations corresponding to those machine readable instructions. In some such examples, the circuitry of FIG. 5 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 6. As such, the FPGA circuitry 900 may be configured and/or structured to effectively instantiate some or all of the operations/functions corresponding to the machine readable instructions of the flowchart of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart of FIG. 6 to perform first operation(s)/function(s), the FPGA circuitry 900 of FIG. 9 may be configured and/or structured to perform second operation(s)/function(s) corresponding to a second portion of the machine readable instructions represented by the flowchart of FIG. 6, and/or an ASIC may be configured and/or structured to perform third operation(s)/function(s) corresponding to a third portion of the machine readable instructions represented by the flowchart of FIG. 6.

It should be understood that some or all of the circuitry of FIG. 5 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 5 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% or +/−5° unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that visually inspect and measure features from inside of holes. Disclosed systems, apparatus, articles of manufacture, and methods detect a gap or other feature within a hole and provide an accurate measurement of the gap based on an image of an interior surface of the hole. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to inspect holes are disclosed herein. Further examples and combinations thereof include the following:

Example 1 includes a probe for providing an image of an interior of a hole of a structure including a camera coupled to a lens, a tube coupled to the lens adjacent a first end of the tube and coaxial with an axis of the lens, and a mirror coupled to the tube adjacent a second end of the tube opposite the first end to reflect light traveling toward a longitudinal axis of the tube to the lens.

Example 2 includes the probe of example 1, wherein the lens is a telecentric lens.

Example 3 includes the probe of any one of examples 1-2, wherein a diameter of the tube is smaller than a diameter of the lens.

Example 4 includes the probe of example 3, further including a light absorbing material disposed between the tube and the lens, the light absorbing material including an opening to allow light to travel between the tube and the lens.

Example 5 includes the probe of any one of examples 1-4, wherein the mirror is a conical mirror coaxial with the axis of the lens.

Example 6 includes the probe of any one of examples 1-5, further including a light source coupled to the lens to direct light towards the mirror.

Example 7 includes the probe of example 6, further including a first polarizer coupled to the camera between the camera and the lens, and a second polarizer coupled to the light source between the light source and the lens, the first polarizer oriented relative the second polarizer such that the first polarizer filters light from the light source.

Example 8 includes the probe of any one of examples 1-7, wherein the mirror is coupled to an inner surface of the tube and the tube includes an opening at the mirror.

Example 9 includes the probe of any one of examples 1-8, further including a focus adjustment coupled to the tube, the focus adjustment to move the tube between a first position and a second position along the longitudinal axis based on a rotational position of the focus adjustment.

Example 10 includes the probe of example 9, further including a sleeve removably coupled to the focus adjustment, the sleeve to surround the tube to increase a diameter of the tube.

Example 11 includes the probe of any one of examples 1-10, further including a controller, the controller including machine readable instructions to command the camera to generate image data corresponding to the interior of the hole, receive the image data from the camera, and measure an axial feature in the image data.

Example 12 includes the probe of example 11, wherein the controller is to measure the axial feature by detecting an edge in the image data.

Example 13 includes the probe of example 12, wherein detecting the edge includes detecting a change in grayscale value beyond a threshold.

Example 14 includes the probe of any one of examples 12-13, wherein detecting the edge includes receiving a user input corresponding to a radial line segment to be analyzed for detecting the edge.

Example 15 includes a controller for an optical inspection device, the controller including interface circuitry to send data to and receive data from the optical inspection device, machine readable instructions, and programmable circuitry to at least one of instantiate or execute the machine readable instructions to receive image data from the optical inspection device, the image data corresponding to an assembly, analyze the image data to detect a boundary within a hole in the assembly, measure the boundary, and generate measurement data corresponding to the boundary.

Example 16 includes the controller of example 15, wherein the boundary is a gap between components of the assembly.

Example 17 includes the controller of any one of examples 15-16, wherein the image data corresponds to light reflecting from a conical mirror onto a planar surface.

Example 18 includes the controller of any one of examples 15-17, wherein measuring the boundary includes counting a number of pixels between a first edge of the boundary and a second edge of the boundary.

Example 19 includes a method of inspecting holes in a structure, the method comprising inserting a camera probe into a hole, instructing the camera probe, via a controller, to collect image data corresponding to an interior surface of the hole, and instructing the controller to process the image data to detect a discontinuity on the interior surface of the hole.

Example 20 includes the method of example 19, further including instructing the controller to measure a width of the discontinuity based on the image data, and storing the measured width as inspection data.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A probe for providing an image of an interior of a hole of a structure comprising:
a camera coupled to a lens;
a tube coupled to the lens adjacent a first end of the tube and coaxial with an axis of the lens; and
a mirror coupled to the tube adjacent a second end of the tube opposite the first end to reflect light traveling toward a longitudinal axis of the tube to the lens.

2. The probe of claim 1, wherein the lens is a telecentric lens.

3. The probe of claim 1, wherein a diameter of the tube is smaller than a diameter of the lens.

4. The probe of claim 3, further including a light absorbing material disposed between the tube and the lens, the light absorbing material including an opening to allow light to travel between the tube and the lens.

5. The probe of claim 1, wherein the mirror is a conical mirror coaxial with the axis of the lens.

6. The probe of claim 1, further including a light source coupled to the lens to direct light towards the mirror.

7. The probe of claim 6, further including:
a first polarizer coupled to the camera between the camera and the lens; and
a second polarizer coupled to the light source between the light source and the lens, the first polarizer oriented relative the second polarizer such that the first polarizer filters light from the light source.

8. The probe of claim 1, wherein the mirror is coupled to an inner surface of the tube and the tube includes an opening at the mirror.

9. The probe of claim 1, further including a focus adjustment coupled to the tube, the focus adjustment to move the tube between a first position and a second position along the longitudinal axis based on a rotational position of the focus adjustment.

10. The probe of claim 9, further including a sleeve removably coupled to the focus adjustment, the sleeve to surround the tube to increase a diameter of the tube.

11. The probe of claim 1, further including a controller, the controller including machine readable instructions to:
command the camera to generate image data corresponding to the interior of the hole;
receive the image data from the camera; and
measure an axial feature in the image data.

12. The probe of claim 11, wherein the controller is to measure the axial feature by detecting an edge in the image data.

13. The probe of claim 12, wherein detecting the edge includes detecting a change in grayscale value beyond a threshold.

14. The probe of claim 12, wherein detecting the edge includes receiving a user input corresponding to a radial line segment to be analyzed for detecting the edge.

15. A controller for an optical inspection device, the controller comprising:
interface circuitry to send data to and receive data from the optical inspection device;
machine readable instructions; and
programmable circuitry to at least one of instantiate or execute the machine readable instructions to:
receive image data from the optical inspection device, the image data corresponding to an assembly;
analyze the image data to detect a boundary within a hole in the assembly;
measure the boundary; and
generate measurement data corresponding to the boundary.

16. The controller of claim 15, wherein the boundary is a gap between components of the assembly.

17. The controller of claim 15, wherein the image data corresponds to light reflecting from a conical mirror onto a planar surface.

18. The controller of claim 15, wherein measuring the boundary includes counting a number of pixels between a first edge of the boundary and a second edge of the boundary.

19. A method of inspecting holes in a structure, the method comprising:
inserting a camera probe into a hole;
instructing the camera probe, via a controller, to collect image data corresponding to an interior surface of the hole; and
instructing the controller to process the image data to detect a discontinuity on the interior surface of the hole.

20. The method of claim 19, further including:
instructing the controller to measure a width of the discontinuity based on the image data; and
storing the measured width as inspection data.
